(19) United States
(12) Patent Application Publication
(10) Pub. No.: US 2025/0202827 A1
(43) Pub. Date: Jun. 19, 2025

(54) Identifying and Scheduling Low Latency, Low Loss, and Scalable Throughput (L4S) Data Flows

(71) Applicant: Cisco Technology, Inc., San Jose, CA (US)

(72) Inventors: Jerome Henry, Pittsboro, NC (US); Juan Carlos Zuniga, Montreal (CA); Binita Gupta, San Diego, CA (US)

(21) Appl. No.: 18/597,880

(22) Filed: Mar. 6, 2024

Related U.S. Application Data
(60) Provisional application No. 63/612,330, filed on Dec. 19, 2023.

(51) Int. Cl. H04L 47/2441; H04L 47/12

(52) U.S. Cl. CPC H04L 47/2441; H04L 47/12

(57) ABSTRACT

Devices, networks, systems, methods, and processes for identifying, classifying, and scheduling Low Latency, Low Loss, and Scalable throughput (LAS) traffic are described herein. A device may receive a data flow comprising one or more data packets. The device may parse the one or more data packets to check for a congestion indicator. Upon detecting the congestion indicator in any data packet, the device can classify or mark the data flow as LAS. The device may schedule the data flow by utilizing an Active Queue Management (AQM) queue for L4S data flows. The device can also mark other uplink or downlink data flows associated with the data flow as L4S. The device can also facilitate LAS capability sharing while associating with one or more wireless devices. The device may utilize a management frame with an extended capabilities field to inform the LAS capability of the device.

### CROSS-REFERENCE TO RELATED APPLICATION

This application claims the benefit of U.S. Provisional Patent Application No. 63/612,330, filed Dec. 19, 2023, which is incorporated by reference herein in its entirety.

The present disclosure relates to digital communication. More particularly, the present disclosure relates to Low Latency, Low Loss, and Scalable throughput (LAS) systems.

### BACKGROUND

Digital communication networks involve communication between multiple interconnected devices. In real-time or near-real-time applications such as streaming video and playing multi-player games on the devices, latency of the communication is required to be minimal. For such applications, Low Latency, Low Loss, and Scalable throughput (LAS) provides low queuing latency, minimal congestion loss, and scalable throughput control. L4S aims to minimize time spent by data packets in queues, thereby reducing overall latency experienced by the applications. LAS also allows for efficiently managing congestion without causing loss of the data packets. Further, LAS provides scalable throughput, thereby allowing the digital networks to adapt to varying levels of demand from the devices.

In conventional systems, L4S assumes presence of a scalable congestion control mechanism at a sender host that can maintain a consistently low average time between congestion signals as flow rate scales. LAS also requires use of a packet identifier at Internet Protocol (IP) layer to facilitate Explicit Congestion Notification (ECN) signaling. For implementing L4S, a dual queue architecture is utilized. In that, LAS traffic is maintained in a separate shallow queue. Some conventional systems also utilize a conditional priority scheduler to assign higher priority to the LAS traffic.

However, multiple challenges arise in wireless shared media access scenarios, which are often stochastic and difficult to predict. These challenges arise especially in densely populated wireless environments where multiple wireless devices access a medium simultaneously. In such wireless shared media access scenarios, efficient scheduling of L4S enabled wireless devices by Access Points (APs) is crucial to minimizing buffer build-up of the LAS enabled wireless devices.

Therefore, there is a need for a technique to identify and schedule the LAS traffic based on one or more flow requirements specified by the L4S enabled wireless devices and based on one or more network Quality of Service (QOS) policies, thereby ensuring optimal performance in the wireless shared media access scenarios.

### SUMMARY OF THE DISCLOSURE

Systems and methods for identifying and scheduling L4S data flows in accordance with embodiments of the disclosure are described herein. In some embodiments, a device includes a processor, and a memory communicatively coupled to the processor, wherein the memory includes a flow scheduling logic. In some embodiments, the flow scheduling logic is configured to receive an upstream data flow including one or more upstream data packets, determine whether an upstream data packet of the one or more upstream data packets includes a congestion indicator, classify the upstream data flow as a Low Latency Low Loss Scalable throughput (LAS) data flow if the upstream data packet includes the congestion indicator, and enqueue the upstream data flow in an LAS queue associated with the LAS data flow.

In some embodiments, the upstream data flow is received from an LAS enabled wireless device.

In some embodiments, the congestion indicator is an Explicit Congestion Notification (ECN) indicator including at least one of an ECN Capable Transport (ECT) value or a Congestion Experienced (CE) value.

In some embodiments, the flow scheduling logic is further configured to transmit an unsolicited dynamic Stream Classification Service (SCS) response frame to the L4S enabled wireless device.

In some embodiments, the flow scheduling logic is further configured to receive an SCS request frame including one or more flow characteristics associated with the upstream data flow from the LAS enabled wireless device in response to the unsolicited dynamic SCS response frame.

In some embodiments, the SCS request frame includes an LAS indicator associated with the upstream data flow.

In some embodiments, the flow scheduling logic is further configured to schedule transmission of the upstream data flow based on at least one of the one or more flow characteristics or the LAS indicator associated with the upstream data flow.

In some embodiments, the flow scheduling logic is further configured to receive a downstream data flow, and detect a second congestion indicator in the downstream data flow associated with a second upstream data flow.

In some embodiments, the flow scheduling logic is further configured to receive the second upstream data flow, classify the second upstream data flow as a second LAS data flow, and enqueue the second upstream data flow in a second LAS queue associated with the second L4S data flow.

In some embodiments, the flow scheduling logic is further configured to transmit a Differentiated Service Code Point (DSCP) policy request to a wireless device.

In some embodiments, the wireless device marks the upstream data flow as the LAS data flow in response to the DSCP policy request.

In some embodiments, a flow scheduling logic is configured to receive a Stream Classification Service (SCS) request indicative of a Low Latency Low Loss Scalable throughput (L4S) data flow associated with a wireless device, receive an upstream data flow including one or more upstream data packets associated with the SCS request, identify a congestion indicator in an upstream data packet of the one or more upstream data packets, and classify the upstream data flow as the LAS data flow based on the congestion indicator.

In some embodiments, the flow scheduling logic is further configured to determine compliance of the upstream data flow with one or more predefined network policies, and enqueue the upstream data flow in an LAS queue associated with the LAS data flow if the upstream data flow complies with the one or more predefined network policies.

In some embodiments, the flow scheduling logic is further configured to decline the SCS request if the upstream data flow does not comply with the one or more predefined network policies, and classify the upstream data flow as a non-L4S data flow.

In some embodiments, the flow scheduling logic is further configured to receive a second SCS request from the wireless device for reception of a downstream L4S data flow, and receive a downstream data flow associated with the wireless device.

In some embodiments, the flow scheduling logic is further configured to classify the downstream data flow as the downstream LAS data flow.

In some embodiments, the flow scheduling logic is further configured to determine compliance of the downstream data flow with the one or more predefined network policies, and classify the downstream data flow as a non-L4S data flow if the downstream data flow does not comply with the one or more predefined network policies.

In some embodiments, a method includes receiving an upstream data flow including one or more upstream data packets from a wireless device, determining whether an upstream data packet of the one or more upstream data packets includes a congestion indicator, classifying the upstream data flow as a Low Latency Low Loss Scalable throughput (LAS) data flow if the upstream data packet includes the congestion indicator, and enqueuing the upstream data flow in an LAS queue associated with the L4S data flow.

In some embodiments, a method further includes transmitting an unsolicited dynamic Stream Classification Service (SCS) response frame to the wireless device, receiving an SCS request frame including one or more flow characteristics associated with the upstream data flow from the wireless device in response to the unsolicited dynamic SCS response frame, and scheduling transmission of the upstream data flow based on the one or more flow characteristics.

In some embodiments, a method further includes receiving a downstream data flow, detecting a second congestion indicator in the downstream data flow, receiving a second upstream data flow corresponding to the downstream data flow, classifying the second upstream data flow as a second LAS data flow, and enqueuing the second upstream data flow in a second LAS queue associated with the second LAS data flow.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a wireless communication network, in accordance with various embodiments of the disclosure;

FIG. 2 is a conceptual illustration of a Stream Classification Service (SCS) in a wireless communication network, in accordance with various embodiments of the disclosure;

FIG. 3 is a conceptual illustration of an Extended Capabilities Element in a frame transmitted a wireless communication network, in accordance with various embodiments of the disclosure;

FIG. 4 is a conceptual network diagram of various environments that a flow scheduler may operate on a plurality of network devices, in accordance with various embodiments of the disclosure;

FIG. 5 is a flowchart depicting a process for marking and enqueuing Low Latency, Low Loss, and Scalable throughput (LAS) data flows, in accordance with various embodiments of the disclosure;

FIG. 6 is a flowchart depicting a process for dynamically transmitting an SCS response, in accordance with various embodiments of the disclosure;

FIG. 7 is a flowchart depicting a process for marking a matching upstream data flow as LAS, in accordance with various embodiments of the disclosure;

FIG. 8 is a flowchart depicting a process for classifying an upstream data flow, in accordance with various embodiments of the disclosure;

FIG. 9 is a flowchart depicting a process for classifying a downstream data flow, in accordance with various embodiments of the disclosure; and

FIG. 10 is a conceptual block diagram of a device suitable for configuration with a flow scheduling logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that identify and schedule Low Latency, Low Loss, and Scalable throughput (LAS) data flows. In many embodiments, an Access Point (AP) may be in communication with a plurality of wireless devices in a wireless communication network. Examples of the wireless devices can include electronic devices, such as but not limited to laptops, smartphones, computers, or tablets etc. The AP can be wirelessly connected to the wireless devices by way of Wi-Fi, for example. The wireless communication network may utilize 6 GHz, 5 GHz or 2.4 GHz bands or Millimeter Waves (mmWave) frequencies, for example. Some of the wireless devices may be LAS enabled wireless devices. When a wireless device attempts to connect to a wireless network, the wireless device may establish a link with the AP. In some embodiments, during establishment of the link, the wireless device and the AP can exchange LAS capability support signaling. In certain embodiments, the LAS capability support signaling may be implemented by way of an ‘L4S Support’ capability field within an Extended Capabilities field in a management frame. In more embodiments, the L4S Support field may a bit that can be set by an L4S enabled wireless device or the AP to indicate LAS capability. The management frame may also be utilized for signaling additional information about the capabilities of the wireless device and/or the AP. Upon receiving the LAS capability support signaling by the LAS enabled wireless device, the AP may provide an optimized LAS communication channel to the LAS enabled wireless device, thereby improving performance of real-time or near-real-time applications in the LAS enabled wireless device. Hence, the LAS capability support signaling of the present disclosure enhances performance of the wireless communication network by allowing the wireless devices to explicitly communicate their LAS capabilities to the APs while associating with the APs.

In a number of embodiments, the L4S enabled wireless device may need to initiate an upstream LAS data flow. In some embodiments, the wireless device may request the initiation of the upstream LAS data flow by utilizing an augmented Stream Classification Service (SCS) request frame. In that, an LAS enabled wireless device can transmit the augmented SCS request frame to the AP. The augmented SCS request frame may be indicative of a request that an upstream data flow initiated by the wireless device be classified as L4S. The augmented SCS request frame may include a field, such as a one-bit field for example, that can be set by the wireless device, to request that the upstream data flow be classified as LAS. The augmented SCS request frame can also include a QoS Characteristics Element indicative of one or more flow characteristics of the upstream LAS data flow requested by the wireless device. Examples of the flow characteristics may include but are not limited to parameters such as bandwidth requirements, latency constraints, or other QoS characteristics etc., for example. Upon receiving the augmented SCS request frame, the AP can determine whether the upstream data flow requested by the wireless device is LAS. Thereafter, the AP may provide the optimized LAS communication channel to the wireless device for transmitting the upstream LAS data flow based on the QoS parameters specified in the SCS request. Hence, by explicitly requesting the upstream LAS data flow, the AP can appropriately handle the upstream LAS data flow even if the wireless device had not previously shared the LAS capability while associating with the AP.

In various embodiments, the wireless device may anticipate reception of a downstream L4S data flow from an LAS enabled network device, such as but not limited to a peer or a server, for example. This expectation may be based on prior knowledge of the LAS capability of the peer or server or an explicit indication received from the peer or server. In this case, the wireless device can initiate an SCS request for the anticipated downstream LAS data flow by transmitting the augmented SCS request frame. The augmented SCS request frame transmitted by the wireless device may include the flow characteristics of the anticipated downstream LAS data flow. The augmented SCS request frame may also include a request to provide the LAS treatment to the anticipated downstream L4S data flow based on the flow characteristics. This facilitates a proactive approach to handle the data flows that are anticipated to be LAS, thereby contributing to a more efficient and responsive wireless communication network.

In additional embodiments, when the wireless device requests the initiation or reception of an LAS data flow through the augmented SCS request frame, the AP may determine whether the L4S data flow contradicts with any network policy based on the flow characteristics of the data flow. In some embodiments, the AP may check the compliance of the LAS data flow with one or more predefined network policies. Examples of the one or more predefined network policies may include but are not limited to network policies that restrict certain types of traffic or that specify certain QoS parameters, bandwidth allocation, or data rate, etc. The network policies can be defined or set by an operator of the wireless communication network. If the AP determines that the LAS data flow complies with the predefined network policies, the AP may provide the L4S treatment to the L4S data flow and may enqueue the LAS data flow in an LAS queue. In some embodiments, the L4S queue may be an Active Queue Management (AQM) queue. In more embodiments, if the AP determines that the L4S data flow does not comply, i.e., contradicts or conflicts with the predefined network policies, the AP may decline the SCS request. In some more embodiments, instead of declining the request, the AP may propose an alternative classification for the conflicting L4S data flow. In additional embodiments, the AP can accept the conflicting L4S data flow but with a non-LAS treatment, thereby enqueuing the conflicting L4S data flow in a classic queue. In many more embodiments, the AP may prioritize other types of data flows over the conflicting L4S data flow. In many additional embodiments, the AP can propose alternative flow characteristics, such as but not limited to adjusting a Maximum Service Data Unit (MSDU) size or the data rate, for example, for the data flow to quality for the LAS treatment. In still many embodiments, the AP may dynamically reclassify the data flow and/or may dynamically propose the alternative flow characteristics when the AP anticipates congestion, faces congestion, or when there are scheduling issues. In some embodiments, the network policies of the wireless communication network may restrict the LAS treatment for certain types of data flows during periods of congestion, for instance, the network policies may explicitly restrict certain types of traffic during peak hours for fair resource allocation. Therefore, upon detecting or anticipating congestion, the AP may dynamically propose the alternative flow characteristics to mitigate the congestion. Hence, the present disclosure provides flexibility to the AP to handle the conflicting L4S data flows, thereby optimizing the treatment of the LAS data flows and effectively managing physical resources of the AP and network resources of the wireless communication network.

In further embodiments, the AP can enqueue the upstream LAS data flow in the LAS queue associated with the L4S data flow. In that, the AP may implement a dual queue, viz., the AQM queue for the LAS data flows and the classic queue for the non-LAS data flows. In some embodiments, the AP may allow the L4S treatment to any data flows that include a congestion indicator. In that, the AP can receive the data flow comprising one or more data packets. The AP may parse the data packets to determine whether any data packet includes the congestion indicator. Upon detecting the congestion indicator in one of the data packets, the AP can treat the data flow as the L4S data flow. In some embodiments, the congestion indicator may be an Explicit Congestion Notification (ECN) indicator. In some more embodiments, the ECN indicator can be an ECN Capable Transport (ECT) value or a Congestion Experienced (CE) value, for example. In certain embodiments, the ECT value of ECT (1) may be classified as LAS, for example. Hence, the AP may not limit the L4S treatment to only the data flows that are explicitly marked as L4S, thereby providing more flexibility in handling the LAS traffic. Such dynamic classification of the L4S data flows overcomes drawbacks faced by conventional systems where the L4S data flows that are not explicitly marked as LAS or that are directed to the wireless device whose LAS capability is unknown, often face latency or congestion. The dynamic classification of the LAS data flows also introduces flexibility by allowing the APs to dynamically mitigate the congestion by providing the L4S treatment based on the ECN indicators in the data flows, thereby improving the throughput of the wireless communication network.

In many more embodiments, the AP may match related upstream data flows and downstream data flows to ease the classification of the LAS data flows. In some embodiments, when the AP receives the downstream data flow including the ECN indicator, the AP may determine that receiving wireless device corresponding to the downstream data flow is LAS enabled. In some more embodiments, the ECN indicator in the downstream data flow may be indicative of the LAS capability of the receiving wireless device. In certain embodiments, the ECN indicator may indicate the congestion on the link. Thereafter, the AP may determine a matching upstream data flow corresponding to the receiving wireless device that can be LAS. In more embodiments, the AP may utilize a device identifier or a flow identifier to determine the matching upstream data flow. The AP can treat the matching upstream data flow as LAS and enqueue the matching upstream data flow in corresponding L4S queue. If the ECN indicator indicates the congestion on the link, the AP may prioritize the matching upstream data flow or may apply one or more QoS policies to mitigate the congestion. Thus, the AP can effectively manage the matching upstream data flows as LAS based on the indication received in the downstream data flow, thereby proactively balancing, and optimizing both: upstream and downstream communication channels in the wireless communication network. Such proactive management of the upstream and downstream communication channels improves responsiveness and adaptability of the wireless communication network in various network conditions.

In many additional embodiments, when the AP detects the ECN indicator in the upstream data flow received from the wireless device, the AP may transmit an unsolicited/dynamic SRS response to the wireless device. In some embodiments, the AP can receive information in the downstream data flow that a receiver of the upstream data flow initiated by the wireless device is LAS enabled or that the receiver experiences link congestion. Thereafter, the AP may initiate the unsolicited/dynamic SCS response to require the wireless device to perform the SCS request for the corresponding matching upstream data flow. The AP can request the wireless device to perform the SCS request for the upstream data flow indicated by a Traffic Classification (TCLAS) element. The AP can describe the upstream data flow and one or more requirements for the LAS data flows. The TCLAS element may describe the flow characteristics, such as but not limited to required bandwidth, latency constraints, and other QoS parameters etc., for example. The TCLAS element may also describe details such as but not limited to source and destination addresses, ports, or protocol information, etc., for example. The AP may optionally require the wireless device to mark the upstream data flow as LAS.

In many further embodiments, the AP can transmit an augmented QoS Management Differentiated Services Code Point (DSCP) Policy request to the wireless device. The augmented QOS Management DSCP Policy request may include the TCLAS to identify the matching upstream data flow. The AP may require the wireless device to mark the matching upstream data flow identified by the TCLAS as LAS. This requirement may be expressed through specific DSCP values, or any other values designated for the L4S data flows, to ensure that the LAS data flows receive the LAS treatment throughout the wireless communication network.

Advantageously, the LAS classification and scheduling system of the present disclosure provides the LAS capability support signaling by allowing the wireless devices and the APs to explicitly communicate their support for L4S while associating with the APs. Further, by allowing the wireless devices to explicitly request the L4S treatment for the upstream data flows, the APs can appropriately handle the upstream L4S data flows even if the wireless devices had not previously shared their LAS capabilities while associating with the APs. The dynamic classification of the L4S data flows in the present disclosure provides flexibility by allowing the APs to dynamically mitigate the congestion by providing the L4S treatment to the data flows based on the ECN indicators in the data flows, thereby improving the throughput of the wireless communication network. Moreover, the present disclosure also facilitates the proactive approach to handle the data flows that are anticipated to be LAS, thereby enhancing efficiency and responsiveness of the wireless communication network. The proactive management of the upstream and downstream communication channels improves adaptability of the wireless communication network in various network conditions. Furthermore, upon detecting the congestion, the APs of the present disclosure can dynamically propose the alternative flow characteristics to mitigate the congestion. The present disclosure also provides flexibility to the APs to handle the conflicting LAS data flows, thereby optimizing the treatment of the LAS data flows and effectively managing the resources in the wireless communication network.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

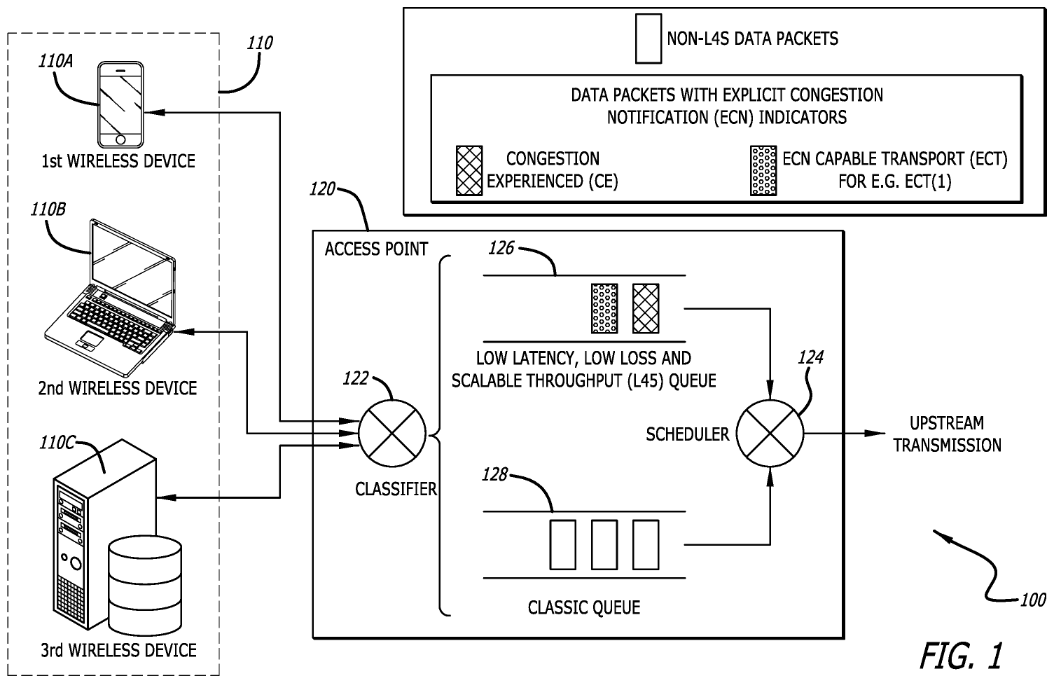

Referring to FIG. 1, a conceptual illustration of a wireless communication network 100, in accordance with various embodiments of the disclosure is shown. In many embodiments, the wireless communication network 100 may include a plurality of wireless devices 110 including the first through third wireless devices 110A, 110B, and 110C. The examples of the wireless devices 110 may include but are not limited to smartphones, computers, laptops, network devices, or any other electronic devices, etc. The wireless devices 110 may be in communication with an Access Point (AP) 120. In that, the wireless devices 110 may be in communication with the AP 120 wirelessly by way of Wi-Fi. The wireless communication network 100 may utilize 6 GHZ, 5 GHz or 2.4 GHz bands or Millimeter Waves (mmWave) frequencies, for example. Some of the wireless devices 110 may be LAS enabled wireless devices 110. The AP 120 may also be L4S enabled. In some embodiments, during establishment of links between the wireless devices 110 and the AP 120, i.e., while associating the wireless devices 110 with the AP 120, the wireless devices 110 and the AP 120 can exchange LAS capability support signaling. Upon receiving the LAS capability support signaling by the LAS enabled wireless devices 110, the AP 120 may provide an optimized LAS communication channel to the L4S enabled wireless devices 110. In that, the AP 120 can include a classifier 122 to classify incoming data flows as LAS or non-LAS. The AP 120 may also implement a dual queue, viz., an Active Queue Management (AQM) queue for LAS data flows, i.e., an LAS queue 126 and a classic queue 128 for non-LAS data flows. The AP 120 can further include a scheduler 124 to schedule the incoming data flows based on whether the incoming data flows are L4S or non-LAS. In certain embodiments, the scheduler 124 may be a conditional priority scheduler that can prioritize the L4S data flows over the non-LAS data flows. Accordingly, the AP 120 may receive the incoming data flows and transmit the incoming data flows based on whether the data flows qualify for L4S treatment or whether the data flows are non-L4S data flows.

In a number of embodiments, one of the LAS enabled wireless devices 110 can initiate an upstream data flow. If the upstream data flow is marked as LAS, the AP 120 may enqueue the upstream data flow in the L4S queue 126. If the upstream data flow is not marked as LAS, the AP 120 may receive a plurality of upstream data packets in the upstream data flow. The AP 120 may parse the upstream data packets to determine whether any upstream data packet includes a congestion indicator. In some embodiments, the congestion indicator may be an Explicit Congestion Notification (ECN) indicator. Upon detecting the ECN indicator in one of the upstream data packets, the AP 120 can treat the upstream data flow as an upstream LAS data flow. In some embodiments, the ECN indicator may be an ECN Capable Transport (ECT) value or a Congestion Experienced (CE) value, for example. In certain embodiments, the ECT value of ECT (1) may be classified as LAS, for example.

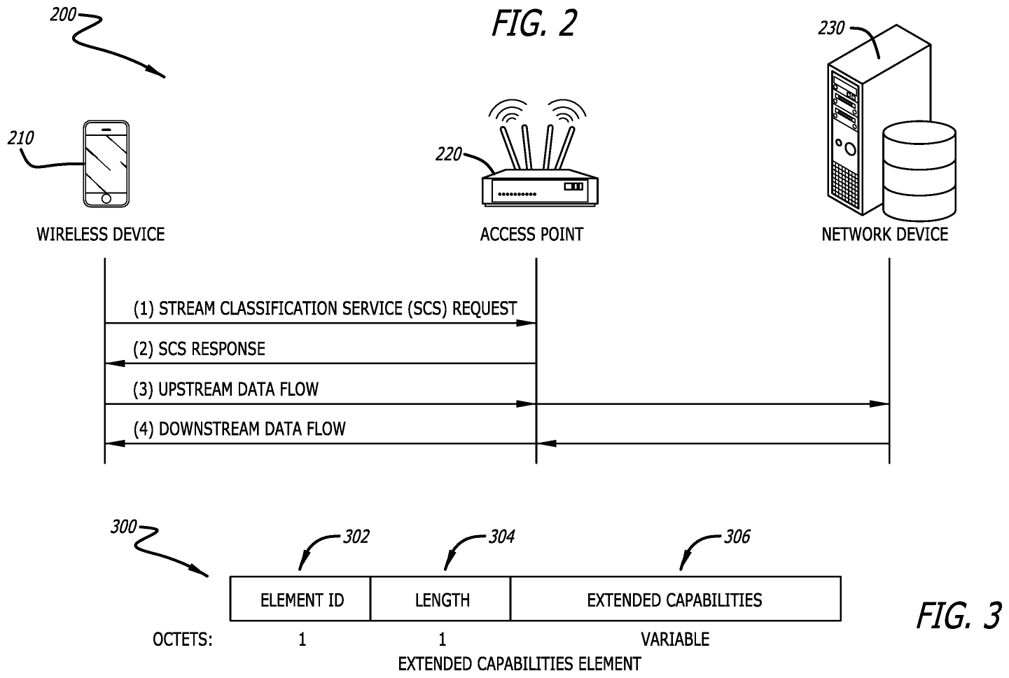

Although a specific embodiment for the wireless communication network 100 for carrying out the various steps, processes, methods, and operations described herein is discussed with respect to FIG. 1, any of a variety of systems and/or processes may be utilized in accordance with embodiments of the disclosure. For example, the AP 120 may facilitate the L4S capability support signaling to enhance the performance of the wireless communication network 100 by allowing the wireless devices 110 to explicitly communicate their L4S capabilities to the AP 120 while associating with the AP 120. The elements depicted in FIG. 1 may also be interchangeable with other elements of FIGS. 2-10 as required to realize a particularly desired embodiment.

Referring to FIG. 2, a conceptual illustration of a Stream Classification Service (SCS) in a wireless communication network 200, in accordance with various embodiments of the disclosure is shown. In many embodiments, the wireless communication network 200 may include a wireless device 210, an AP 220, and a network device 230. In some embodiments, the network device 230 can be within the wireless communication network 200. In certain embodiments, the network device 230 can be external to the wireless communication network 200. In more embodiments, the network device 230 may be a server that provides service to one or more applications in the wireless device 210. Examples of the one or more applications may include but are not limited to real-time and/or near-real-time applications such as streaming or playing multi-player video games. The wireless device 210 may be in communication with the AP 220 through wireless communication channels, such as but not limited to Wi-Fi, for example.

In a number of embodiments, the wireless device 210 can be an LAS enabled wireless device 210. The wireless device 210 may need to initiate the upstream LAS data flow. In some embodiments, the wireless device 210 may request the initiation of the upstream L4S data flow by utilizing an augmented SCS request frame. In that, as shown in step 1 in FIG. 2, the wireless device 210 can transmit the augmented SCS request frame to the AP 220. The augmented SCS request frame may be indicative of a request that the upstream data flow initiated by the wireless device 210 be classified as L4S. The augmented SCS request frame may include a field, such as a one-bit field for example, that can be set by the wireless device 210, to request that the upstream data flow be classified as LAS. The augmented SCS request frame can also include a QoS Characteristics Element indicative of one or more flow characteristics of the upstream L4S data flow requested by the wireless device 210. As shown in step 2 in FIG. 2, the AP 220 may transmit an SCS response to the wireless device 210. As shown in step 3 in FIG. 2, the AP 220 can determine whether the upstream data flow requested by the wireless device 210 is LAS. Thereafter, the AP 220 may provide the optimized L4S communication channel to the wireless device 210 for transmitting the upstream LAS data flow based on the QoS parameters specified in the SCS request.

In various embodiments, the wireless device 210 may anticipate reception of a downstream LAS data flow from the network device 230. This expectation may be based on prior knowledge of the LAS capability of the network device 230, or an explicit indication received from the network device 230. In this case, the wireless device 210 can initiate an SCS request for the anticipated downstream LAS data flow by transmitting a second augmented SCS request frame. The second augmented SCS request frame transmitted by the wireless device 210 may include the flow characteristics of the anticipated downstream LAS data flow. The second augmented SCS request frame may also include a request to provide the L4S treatment to the anticipated downstream LAS data flow based on the flow characteristics. Thereafter, as shown in step 4 in FIG. 2, the AP 220 may facilitate the reception of the downstream LAS data flow by the wireless device 210 from the network device 230.

Although a specific embodiment for the SCS in the wireless communication network 200 for carrying out the various steps, processes, methods, and operations described herein is discussed with respect to FIG. 2, any of a variety of systems and/or processes may be utilized in accordance with embodiments of the disclosure. For example, the AP 220 can facilitate a proactive approach to handle the data flows that are anticipated to be LAS, thereby enhancing the efficiency and responsiveness of the wireless communication network 200. The elements depicted in FIG. 2 may also be interchangeable with other elements of FIG. 1 and FIGS. 3-10 as required to realize a particularly desired embodiment.

Referring to FIG. 3, a conceptual illustration of an Extended Capabilities Element in a management frame 300 transmitted in the wireless communication network, in accordance with various embodiments of the disclosure is shown. In many embodiments, the management frame 300 can include an element identifier (Element ID) 302, a length field 304, and an Extended Capabilities field 306. In many embodiments, during establishment of the link, the wireless device and the AP can exchange L4S capability support signaling. In certain embodiments, the LAS capability support signaling may be implemented by way of an ‘L4S Support’ capability field within the Extended Capabilities field 306 in the management frame 300. In more embodiments, the LAS Support field may a bit that can be set by an LAS enabled wireless device or the AP to indicate LAS capability. The management frame 300 may also be utilized for signaling additional information about the capabilities of the wireless device and/or the AP. Upon receiving the LAS capability support signaling by the L4S enabled wireless device, the AP may provide an optimized LAS communication channel to the LAS enabled wireless device, thereby improving performance of real-time or near-real-time applications in the LAS enabled wireless device.

In a number of embodiments, the Extended Capabilities field 306 in the management frame 300 can include a new assigned bit, i.e., LAS Support field indicative of the L4S Support. The L4S Support field can be indicative of the support for generating, transmitting, or processing the L4S data flows by the wireless device and/or the AP. The wireless device and/or the AP can set the L4S Support field to ‘1’ to indicate that the wireless device and/or the AP can support the LAS data flows. If the wireless device and/or the AP cannot support the LAS data flows, the L4S Support field may be set to ‘0’. In some embodiments, the AP can signal the LAS Support capability in the Extended Capabilities field 306 in the Beacon, Probe Response, or FILS Discovery and (Re) Association Response frames etc. for example. In some more embodiments, the wireless device can signal the L4S Support capability in the Extended Capabilities field 206 in Probe Request and (Re) Association Request frames etc. for example.

Although a specific embodiment for the management frame 300 in the wireless communication network for carrying out the various steps, processes, methods, and operations described herein is discussed with respect to FIG. 3, any of a variety of systems and/or processes may be utilized in accordance with embodiments of the disclosure. For example, the AP and/or the wireless device may utilize any frame structure to communicate the LAS Capabilities. The elements depicted in FIG. 3 may also be interchangeable with other elements of FIGS. 1-2 and FIGS. 4-10 as required to realize a particularly desired embodiment.

Referring to FIG. 3, a conceptual network diagram 400 of various environments that a flow scheduler may operate on a plurality of network devices, in accordance with various embodiments of the disclosure is shown. Those skilled in the art will recognize that the flow scheduler can be comprised of various hardware and/or software deployments and can be configured in a variety of ways. In many embodiments, the flow scheduler can be configured as a standalone device, exist as a logic in another network device, be distributed among various network devices operating in tandem, or remotely operated as part of a cloud-based network management tool. In further embodiments, one or more servers 410 can be configured with or otherwise operate the flow scheduler. In many embodiments, the flow scheduler may operate on one or more servers 410 connected to a communication network 420. The communication network 420 can include wired networks or wireless networks. In many embodiments, the communication network 420 may be a Wi-Fi network operating on various frequency bands, such as, 2.4 GHZ, 5 GHz, or 6 GHz. In further embodiments, the flow scheduler operating on the servers 410 can facilitate the transmission and reception of the LAS data flows. The flow scheduler can be provided as a cloud-based service that can service remote networks, such as, but not limited to a deployed network 440. In many embodiments, the flow scheduler can be a logic that detects if the data flows are LAS.

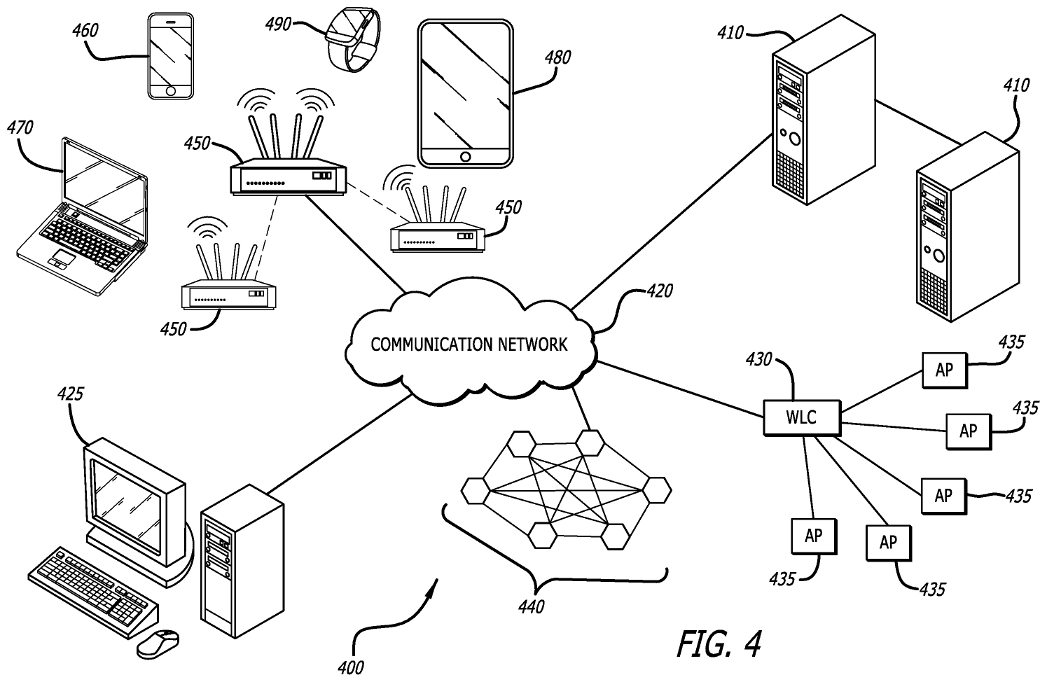

However, in additional embodiments, the flow scheduler may be operated as a distributed logic across multiple network devices. In the embodiment depicted in FIG. 4, a plurality of APs 450 can operate as the flow scheduler in a distributed manner or may have one specific device operate as the flow scheduler for all of the neighboring or sibling APs 450. The APs 450 facilitate Wi-Fi connections for various electronic devices, such as but not limited to mobile computing devices including laptop computers 470, cellular phones 460, portable tablet computers 480 and wearable computing devices 490.

In further embodiments, the flow scheduler may be integrated within another network device. In the embodiment depicted in FIG. 4, a wireless LAN controller (WLC) 430 may have an integrated flow scheduler that the WLC 430 can use to classify and schedule the LAS data flows within the various APs 435 that the WLC 430 is connected to, either wired or wirelessly. In still more embodiments, a personal computer 425 may be utilized to access and/or manage various aspects of the flow scheduler, either remotely or within the network itself. In the embodiment depicted in FIG. 4, the personal computer 425 communicates over the communication network 420 and can access the flow scheduler of the servers 410, or the network APs 450, or the WLC 430.

Although a specific embodiment for various environments that the flow scheduler may operate on a plurality of network devices suitable for carrying out the various steps, processes, methods, and operations described herein is discussed with respect to FIG. 4, any of a variety of systems and/or processes may be utilized in accordance with embodiments of the disclosure. In many non-limiting examples, the flow scheduler may be provided as a device or software separate from the network devices or the flow scheduler may be integrated into the network devices. The elements depicted in FIG. 4 may also be interchangeable with other elements of FIGS. 1-3 and 5-10 as required to realize a particularly desired embodiment.

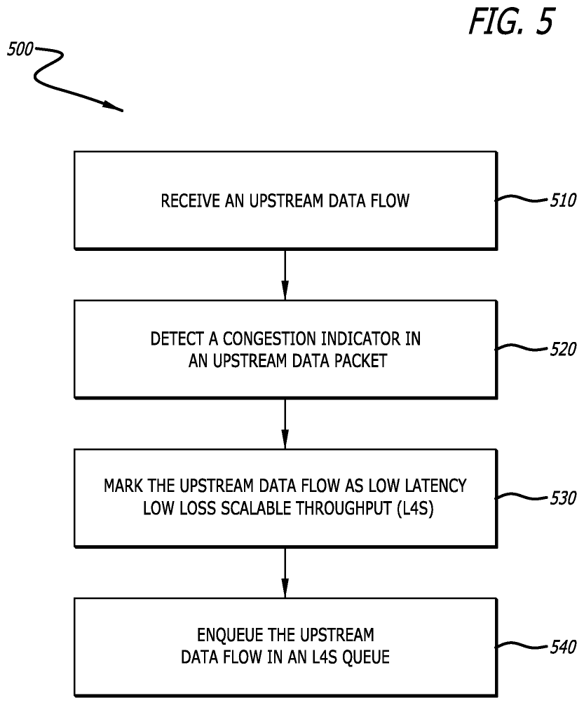

Referring now to FIG. 5, a flowchart depicting a process 500 for marking and enqueuing the L4S data flows, in accordance with various embodiments of the disclosure is shown. In many embodiments, the process 500 may receive the upstream data flow (block 510). In some embodiments, the process 500 can be implemented by the AP which is wirelessly in communication with one or more LAS enabled wireless devices and/or one or more non-L4S enabled wireless devices. In certain embodiments, the wireless devices may possess varying level of L4S capabilities. In more embodiments, the process 500 can identify and handle the LAS data flows and the non-LAS data flows simultaneously. In some more embodiments, the upstream data flow may or may not be marked as LAS by the wireless devices. In numerous embodiments, the upstream data flow can include the one or more upstream data packets.

In a number of embodiments, the process 500 may detect the ECN indicator in any upstream data packet of the one or more upstream data packets (block 520). In some embodiments, the process 500 can parse the upstream data packets to determine whether any upstream data packet includes the ECN indicator. In certain embodiments, the process 500 may inspect headers and other fields of the upstream data packets. In more embodiments, the ECN indicator may be an ECT value or a CE value, for example. In more embodiments, the ECT value of ECT (1) may be classified as LAS, for example.

In various embodiments, the process 500 can mark the upstream data flow as the upstream L4S data flow (block 530). In some embodiments, upon detecting the ECN indicator in any upstream data packet, the process 500 may treat the upstream data flow as the upstream LAS data flow. In certain embodiments, the process 500 can appropriately handle the upstream LAS data flow even if the wireless device had not previously shared the LAS capability while associating with the AP.

In additional embodiments, the process 500 may enqueue the upstream L4S data flow in an LAS queue (block 540). In some embodiments, the L4S queue can be the AQM queue. In certain embodiments, the process 500 may implement the dual queue, viz., the AQM queue for the L4S data flows and the classic queue for the non-LAS data flows. In more embodiments, the AQM queue can actively manage congestion by dropping or ECN marking the data packets in any data flow based on network conditions. In some more embodiments, the utilization of the AQM queue for the LAS data flows may allow for effective congestion control and optimization.

Although a specific embodiment for the process 500 for marking and enqueuing the L4S data flows for carrying out the various steps, processes, methods, and operations described herein is discussed with respect to FIG. 5, any of a variety of systems and/or processes may be utilized in accordance with embodiments of the disclosure. For example, the process 500 may dynamically classify the L4S data flows that are not explicitly marked as LAS or that are directed to the wireless device whose LAS capability is unknown. The elements depicted in FIG. 5 may also be interchangeable with other elements of FIGS. 1-4 and FIGS. 6-10 as required to realize a particularly desired embodiment.

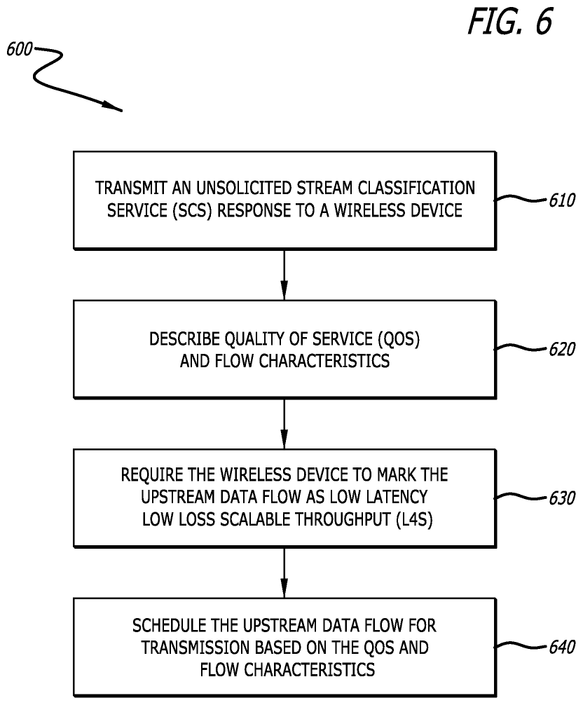

Referring now to FIG. 6, a flowchart depicting a process 600 for dynamically transmitting the SCS response for the upstream data flow, in accordance with various embodiments of the disclosure is shown. In many embodiments, the process 600 may transmit the unsolicited/dynamic SCS response to the wireless device (block 610). In some embodiments, the process 600 can receive information in the downstream data flow that the receiver of the upstream data flow initiated by the wireless device is LAS enabled or that the receiver experiences link congestion. Thereafter, in certain embodiments, the process 600 may initiate the unsolicited/dynamic SCS response to require the wireless device to perform the SCS request for the corresponding matching upstream data flow.

In a number of embodiments, the process 600 can describe the QoS and flow characteristics (block 620). In some embodiments, the process 600 may describe the upstream data flow and one or more requirements for the LAS data flows. In certain embodiments, the TCLAS element may describe the flow characteristics, such as but not limited to required bandwidth, latency constraints, or other QoS parameters etc., for example. In more embodiments, the TCLAS element may also describe details such as but not limited to source and destination addresses, ports, or protocol information, etc., for example.

In various embodiments, the process 600 may require the wireless device to mark the upstream data flow as L4S (block 630). In some embodiments, the process 600 can request the wireless device to perform the SCS request for the upstream data flow indicated by the TCLAS element. In certain embodiments, the wireless device may mark the upstream data flow as LAS based on the unsolicited/dynamic SCS response. In more embodiments, the wireless device may mark the upstream data flow as L4S by way of the SCS request. In some more embodiments, the STS request can indicate the QoS and flow characteristics specified by the wireless device for upstream data flow as LAS.

In further embodiments, the process 600 can schedule the upstream data flow for transmission based on the QoS and flow characteristics (block 640). In some embodiments, the process 600 may enqueue the upstream data flow marked as LAS into the LAS queue corresponding to the upstream LAS data flow. In certain embodiments, the process 600 can schedule the upstream L4S data flow based on the QoS and flow characteristics.

Although a specific embodiment for the process 600 for dynamically transmitting the SCS response for carrying out the various steps, processes, methods, and operations described herein is discussed with respect to FIG. 6, any of a variety of systems and/or processes may be utilized in accordance with embodiments of the disclosure. For example, the process 600 may ensure that the upstream data flows qualifying for the L4S treatment receive the LAS treatment throughout the wireless communication network. The elements depicted in FIG. 6 may also be interchangeable with other elements of FIGS. 1-5 and FIGS. 7-10 as required to realize a particularly desired embodiment.

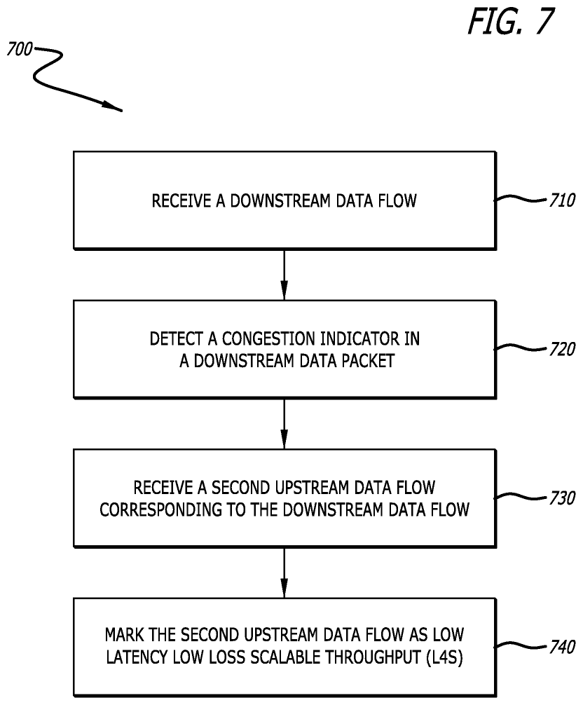

Referring now to FIG. 7, a flowchart depicting a process 700 for marking the matching upstream data flow as LAS, in accordance with various embodiments of the disclosure is shown. In some embodiments, the process 700 can receive the downstream data flow (block 710). In certain embodiments, the downstream data flow may include one or more downstream data packets. In more embodiments, the process 700 may parse the one or more downstream data packets to check for the ECN indicator.

In a number of embodiments, the process 700 may detect the ECN indicator in any downstream data packet of the downstream data flow (block 720). In some embodiments, the ECN indicator in the downstream data flow may be indicative of the L4S capability of the receiving wireless device. In certain embodiments, the ECN indicator may indicate the congestion on the link.

In various embodiments, the process 700 can receive a second upstream data flow corresponding to the downstream data flow (block 730). In some embodiments, the process 700 may match the second upstream data flow with the downstream data flow based on the device identifier or the flow identifier. In certain embodiments, the process 700 can match the second upstream data flow with the downstream data flow based on the ECN indicator received in the downstream data flow.

In additional embodiments, the process 700 may require the wireless device to mark the second upstream data flow as LAS (block 740). In some embodiments, the process 700 can transmit an augmented QoS Management Differentiated Services Code Point (DSCP) Policy request to the wireless device. In certain embodiments, the augmented QoS Management DSCP Policy request may include the TCLAS to identify the matching upstream data flow. In more embodiments, the process 700 may require the wireless device to mark the matching upstream data flow identified by the TCLAS as L4S. In some more embodiments, for example, this requirement may be expressed through specific DSCP values, or any other values designated for the LAS data flows, for example. In numerous embodiments, the augmented QoS DSCP Policy request can be utilized to require marking the matching upstream data flow as LAS based on the ECN indicator in the corresponding downstream data flow.

Although a specific embodiment for the process 700 for marking the matching upstream data flow as LAS for carrying out the various steps, processes, methods, and operations described herein is discussed with respect to FIG. 7, any of a variety of systems and/or processes may be utilized in accordance with embodiments of the disclosure. For example, the process 700 can effectively manage the matching upstream data flows as L4S based on the indication received in the downstream data flow, thereby proactively balancing, and optimizing both: upstream and downstream communication channels in the wireless communication network, which improves responsiveness and adaptability of the wireless communication network in various network conditions. The elements depicted in FIG. 7 may also be interchangeable with other elements of FIGS. 1-6 and FIGS. 8-10 as required to realize a particularly desired embodiment.

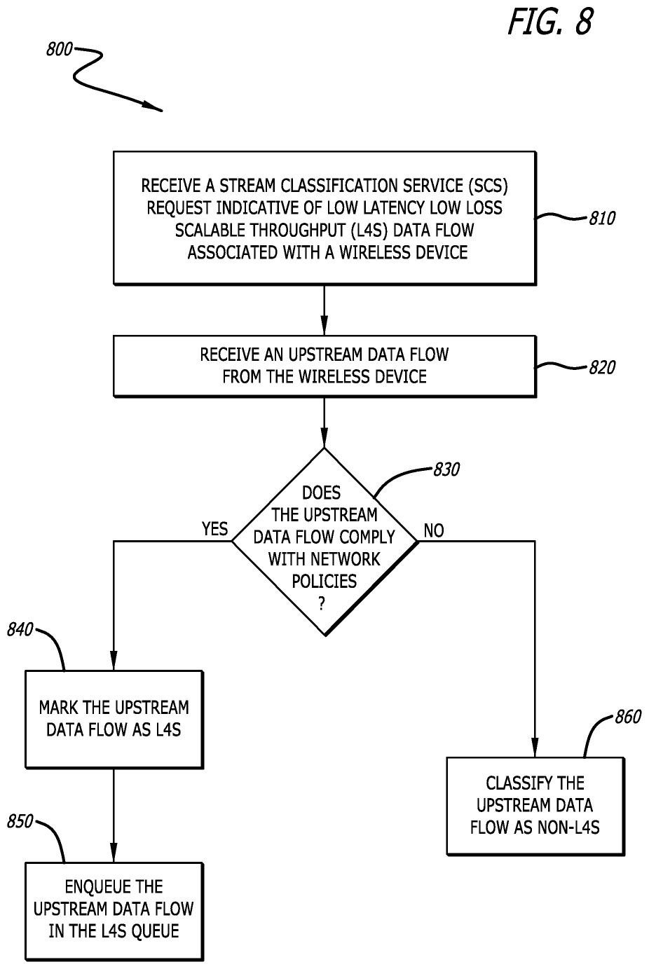

Referring now to FIG. 8, a flowchart depicting a process 800 for classifying the upstream data flow, in accordance with various embodiments of the disclosure is shown. In some embodiments, the process 800 can receive the SCS request indicative of the L4S capability from the wireless device (block 810). In certain embodiments, the wireless device may request the initiation of the upstream L4S data flow by transmitting the augmented SCS request frame. In some embodiments, the augmented SCS request frame may be indicative of the request that the upstream data flow initiated by the wireless device be classified as L4S. In certain embodiments, the augmented SCS request frame may include the field, such as the one-bit field for example, that can be set by the wireless device, to request that the upstream data flow be classified as LAS. In more embodiments, the augmented SCS request frame can also include the QoS Characteristics Element indicative of one or more flow characteristics of the upstream L4S data flow requested by the wireless device. In some more examples, examples of the flow characteristics may include but are not limited to parameters such as bandwidth requirements, latency constraints, or other QoS characteristics etc.

In a number of embodiments, the process 800 may receive the upstream data flow from the wireless device (block 820). In some embodiments, upon receiving the augmented SCS request frame, the process 800 can determine whether the upstream data flow requested by the wireless device is LAS. Thereafter, in certain embodiments, the process 800 may provide the optimized L4S communication channel to the wireless device for transmitting the upstream L4S data flow based on the QoS parameters specified in the SCS request.

In various embodiments, the process 800 can determine if the upstream data flow complies with the network policies (block 830). In some embodiments, the examples of the one network policies may include restrictions on certain types of traffic or specification of certain QoS parameters, bandwidth allocation, or data rate, etc. for example. In certain embodiments, the network policies can be predefined by the operator of the wireless communication network.

In additional embodiments, if the process 800 determines that the upstream data flow complies with the network policies, the process 800 may mark the upstream data flow as LAS (block 840). In some embodiments, the process 800 can mark the upstream data flow by inserting the ECN indicator. In certain embodiments, the ECN indicator may be ECT or in case of congestion, CE.

In further embodiments, the process 800 can enqueue the upstream data flow in the LAS queue (block 850). In some embodiments, the process 800 may implement the dual queue, viz., the AQM queue for L4S data flows and the classic queue for non-LAS data flows. In certain embodiments, the AQM queue can actively manage congestion by dropping or ECN marking the upstream data packets in the upstream data flow based on the network conditions. In more embodiments, the utilization of the AQM queue for the LAS data flows may allow for effective congestion control and optimization.

In many more embodiments, if the process 800 determines that the upstream data flow contradicts or conflicts with the network policies, the process 800 may classify the conflicting upstream data flow as non-L4S (block 860). In some embodiments, the process 800 may decline the SCS request. In certain embodiments, instead of declining the request, the process 800 may propose the alternative classification for the conflicting upstream data flow. In more embodiments, the process 800 can accept the conflicting upstream data flow but with the non-LAS treatment, thereby enqueuing the conflicting upstream data flow in the classic queue. In some more embodiments, the process 800 may prioritize other types of data flows over the conflicting upstream data flow. In numerous embodiments, the process 800 can propose alternative flow characteristics, such as but not limited to adjusting the MSDU size or the data rate, for example, for the upstream data flow to quality for the L4S treatment.

Although a specific embodiment for the process 800 for classifying the upstream data flow for carrying out the various steps, processes, methods, and operations described herein is discussed with respect to FIG. 8, any of a variety of systems and/or processes may be utilized in accordance with embodiments of the disclosure. For example, the process 800 can effectively handle the conflicting upstream LAS data flows. The elements depicted in FIG. 8 may also be interchangeable with other elements of FIGS. 1-7 and FIGS. 9-10 as required to realize a particularly desired embodiment.

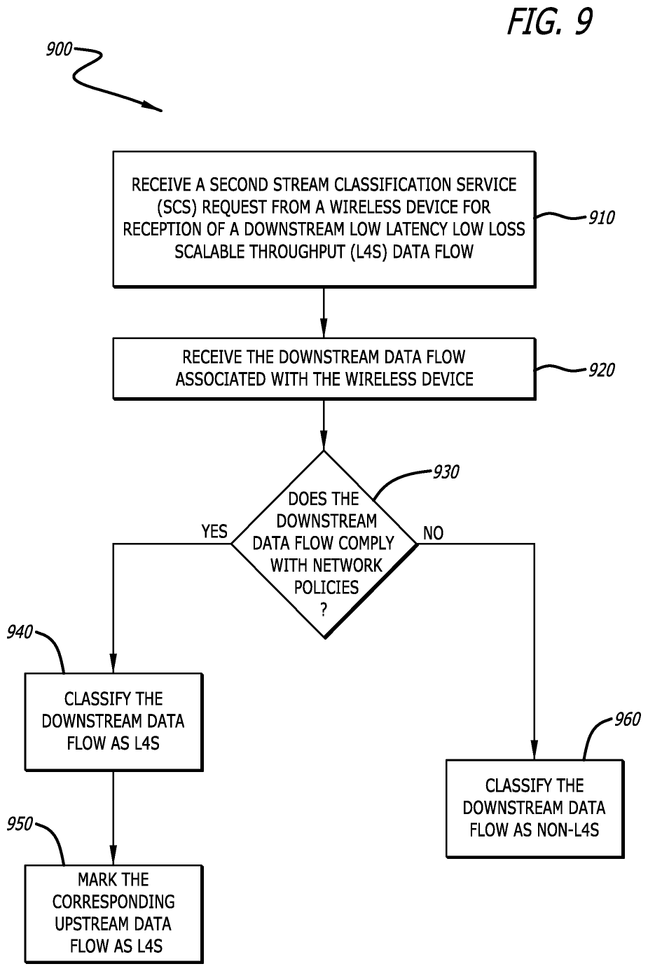

Referring now to FIG. 9, a flowchart depicting a process 900 for classifying the downstream data flow, in accordance with various embodiments of the disclosure is shown. In many embodiments, the process 900 can receive a second augmented SCS request indicative of receiving an anticipated downstream L4S data flow (block 910). In some embodiments, this expectation may be based on prior knowledge of the LAS capability of the peer or server or the explicit indication received from the peer or server. In certain embodiments, the second augmented SCS request frame transmitted by the wireless device may include the flow characteristics of the anticipated downstream LAS data flow. In more embodiments, the second augmented SCS request frame may also include the request to provide the L4S treatment to the anticipated downstream LAS data flow based on the flow characteristics.

In a number of embodiments, the process 900 may receive the downstream data flow from the peer or server (block 920). In some embodiments, upon receiving the second augmented SCS request frame, the process 900 can determine whether the downstream data flow requested by the wireless device is LAS. Thereafter, in certain embodiments, the process 900 may provide the optimized L4S communication channel for receiving the downstream LAS data flow from the peer or server.

In various embodiments, the process 900 can determine if the downstream data flow complies with the network policies (block 930). In some embodiments, the examples of the one network policies may include restrictions on certain types of traffic or specification of certain QoS parameters, bandwidth allocation, or data rate, etc. for example. In certain embodiments, the network policies can be predefined by the operator of the wireless communication network.

In additional embodiments, if the process 900 determines that the downstream data flow complies with the network policies, the process 900 may mark the downstream data flow as L4S (block 940). In some embodiments, the process 900 can mark the downstream data flow by inserting the ECN indicator. In certain embodiments, the ECN indicator may be ECT or in case of congestion, CE.

In further embodiments, the process 900 can enqueue the downstream data flow in the L4S queue (block 950). In some embodiments, the process 900 may implement the dual queue, viz., the AQM queue for L4S data flows and the classic queue for non-LAS data flows. In certain embodiments, the AQM queue can actively manage congestion by dropping or ECN marking the downstream data packets in the downstream data flow based on the network conditions. In more embodiments, the utilization of the AQM queue for the LAS data flows may allow for effective congestion control and optimization.

In many more embodiments, if the process 900 determines that the downstream data flow contradicts or conflicts with the network policies, the process 900 may classify the conflicting downstream data flow as non-L4S (block 960). In some embodiments, the process 900 may decline the SCS request. In certain embodiments, instead of declining the request, the process 900 may propose the alternative classification for the conflicting downstream data flow. In more embodiments, the process 900 can accept the conflicting downstream data flow but with a non-L4S treatment, thereby enqueuing the conflicting downstream data flow in the classic queue. In some more embodiments, the process 900 may prioritize other types of data flows over the conflicting downstream data flow. In numerous embodiments, the process 900 can propose alternative flow characteristics, such as but not limited to adjusting the MSDU size or the data rate, etc. for example, for the downstream data flow to quality for the LAS treatment.

Although a specific embodiment for the process 900 for classifying the downstream data for carrying out the various steps, processes, methods, and operations described herein is discussed with respect to FIG. 9, any of a variety of systems and/or processes may be utilized in accordance with embodiments of the disclosure. For example, the process 900 can effectively handle the conflicting downstream LAS data flows. The elements depicted in FIG. 9 may also be interchangeable with other elements of FIGS. 1-8 and FIG. 10 as required to realize a particularly desired embodiment.

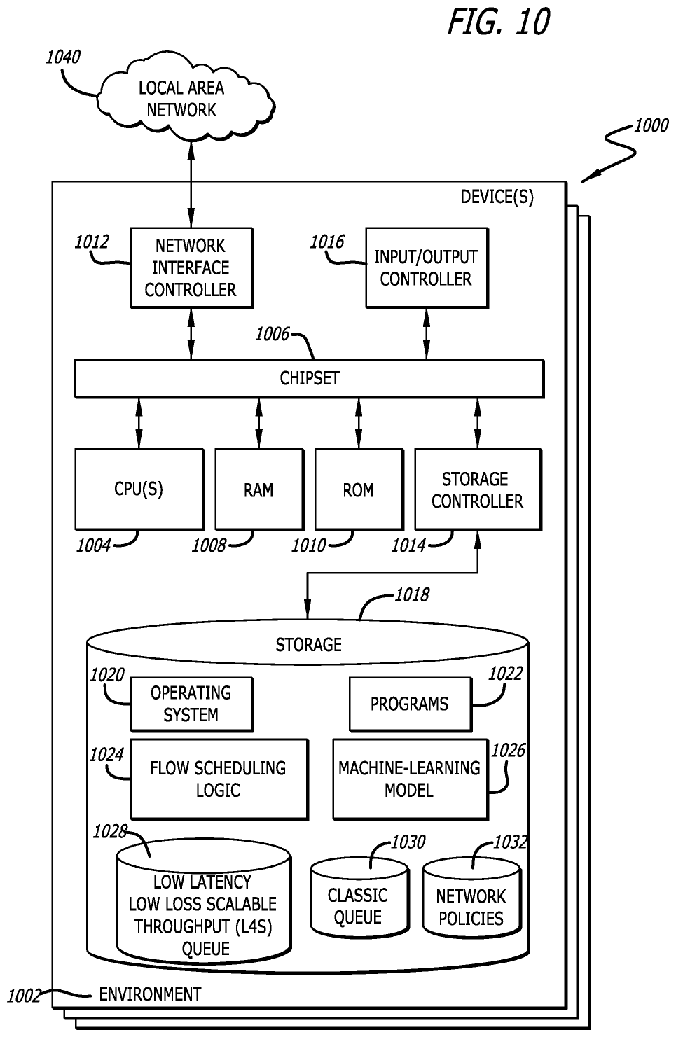

Referring to FIG. 10, a conceptual block diagram of a device 1000 suitable for configuration with a flow scheduling logic, in accordance with various embodiments of the disclosure is shown. The embodiment of the conceptual block diagram depicted in FIG. 10 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 10 can also illustrate an access point, a switch, or a router in accordance with various embodiments of the disclosure. The device 1000 may, in many non-limiting examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In a number of embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Additional embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for instance, store an operating system 1020, applications 1022, LAS queue 1028, classic queue 1030, and network policies 1032 which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The L4S queue 1028 can store the L4S data packets in the LAS data flows. The L4S queue 1028 may be the AQM queue. The classic queue 1030 may store the non-LAS data packets in the non-LAS queue. The network policies 1032 may store the one or more predefined network policies.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

In many more embodiments, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In many additional embodiments, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9. In certain embodiments, the device 1000 can also include computer-readable storage media having instructions stored thereupon for performing any of the other computer-implemented operations described herein.

In many further embodiments, the device 1000 may include a flow scheduling logic 1024. The flow scheduling logic 1024 can be configured to perform one or more of the various steps, processes, operations, and/or other methods that are described above. Often, the flow scheduling logic 1024 can be a set of instructions stored within a non-volatile memory that, when executed by the processor(s)/controller(s) 1004 can carry out these steps, etc. In some embodiments, the flow scheduling logic 1024 may be a client application that resides on a network-connected device, such as, but not limited to, a server, switch, personal or mobile computing device in a single or distributed arrangement. The flow scheduling logic 1024 can identify, classify, and schedule the LAS data flows.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

Finally, in numerous additional embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026.

The ML model(s) 1026 can be configured to generate inferences to make predictions or draw conclusions from data. An inference can be considered the output of a process of applying a model to new data. This can occur by learning from at least the LAS queue 1028, the classic queue 1030, and the network policies 1032 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although a specific embodiment for the device 1000 suitable for configuration with the flow scheduling logic for carrying out the various steps, processes, methods, and operations described herein is discussed with respect to FIG. 10, any of a variety of systems and/or processes may be utilized in accordance with embodiments of the disclosure. For example, the device 1000 may be in a virtual environment such as a cloud-based network administration suite, or it may be distributed across a variety of network devices or switches. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a flow scheduling logic, configured to:
receive an upstream data flow including one or more upstream data packets;
determine whether an upstream data packet of the one or more upstream data packets includes a congestion indicator;
classify the upstream data flow as a Low Latency Low Loss Scalable throughput (L4S) data flow if the upstream data packet includes the congestion indicator; and
enqueue the upstream data flow in an LAS queue associated with the L4S data flow.

2. The device of claim 1, wherein the upstream data flow is received from an LAS enabled wireless device.

3. The device of claim 2, wherein the congestion indicator is an Explicit Congestion Notification (ECN) indicator including at least one of: an ECN Capable Transport (ECT) value or a Congestion Experienced (CE) value.

4. The device of claim 3, wherein the flow scheduling logic is further configured to transmit an unsolicited dynamic Stream Classification Service (SCS) response frame to the LAS enabled wireless device.

5. The device of claim 4, wherein the flow scheduling logic is further configured to receive an SCS request frame including one or more flow characteristics associated with the upstream data flow from the LAS enabled wireless device in response to the unsolicited dynamic SCS response frame.

6. The device of claim 5, wherein the SCS request frame comprises an LAS indicator associated with the upstream data flow.

7. The device of claim 6, wherein the flow scheduling logic is further configured to schedule transmission of the upstream data flow based on at least one of: the one or more flow characteristics or the LAS indicator associated with the upstream data flow.

8. The device of claim 7, wherein the flow scheduling logic is further configured to:
receive a downstream data flow; and
detect a second congestion indicator in the downstream data flow associated with a second upstream data flow.

9. The device of claim 8, wherein the flow scheduling logic is further configured to:
receive the second upstream data flow;
classify the second upstream data flow as a second L4S data flow; and
enqueue the second upstream data flow in a second L4S queue associated with the second LAS data flow.

10. The device of claim 1, wherein the flow scheduling logic is further configured to transmit a Differentiated Service Code Point (DSCP) policy request to a wireless device.

11. The device of claim 10, wherein the wireless device marks the upstream data flow as the L4S data flow in response to the DSCP policy request.

12. A device, comprising:
a processor;
a memory communicatively coupled to the processor; and
a flow scheduling logic, configured to:
receive a Stream Classification Service (SCS) request indicative of a Low Latency Low Loss Scalable throughput (LAS) data flow associated with a wireless device;
receive an upstream data flow including one or more upstream data packets associated with the SCS request;
identify a congestion indicator in an upstream data packet of the one or more upstream data packets; and
classify the upstream data flow as the LAS data flow based on the congestion indicator.

13. The device of claim 12, wherein the flow scheduling logic is further configured to:
determine compliance of the upstream data flow with one or more predefined network policies; and
enqueue the upstream data flow in an LAS queue associated with the LAS data flow if the upstream data flow complies with the one or more predefined network policies.

14. The device of claim 13, wherein the flow scheduling logic is further configured to:
decline the SCS request if the upstream data flow does not comply with the one or more predefined network policies; and
classify the upstream data flow as a non-LAS data flow.

15. The device of claim 14, wherein the flow scheduling logic is further configured to:
receive a second SCS request from the wireless device for reception of a downstream LAS data flow; and
receive a downstream data flow associated with the wireless device.

16. The device of claim 15, wherein the flow scheduling logic is further configured to classify the downstream data flow as the downstream LAS data flow.

17. The device of claim 16, wherein the flow scheduling logic is further configured to:
determine compliance of the downstream data flow with the one or more predefined network policies; and
classify the downstream data flow as a non-L4S data flow if the downstream data flow does not comply with the one or more predefined network policies.

18. A method, comprising:
receiving an upstream data flow including one or more upstream data packets from a wireless device;
determining whether an upstream data packet of the one or more upstream data packets includes a congestion indicator;
classifying the upstream data flow as a Low Latency Low Loss Scalable throughput (L4S) data flow if the upstream data packet includes the congestion indicator; and
enqueuing the upstream data flow in an LAS queue associated with the L4S data flow.

19. The method of claim 18, further comprising:
transmitting an unsolicited dynamic Stream Classification Service (SCS) response frame to the wireless device;
receiving an SCS request frame including one or more flow characteristics associated with the upstream data flow from the wireless device in response to the unsolicited dynamic SCS response frame; and
scheduling transmission of the upstream data flow based on the one or more flow characteristics.

20. The method of claim 19, further comprising:
receiving a downstream data flow;
detecting a second congestion indicator in the downstream data flow;
receiving a second upstream data flow corresponding to the downstream data flow;
classifying the second upstream data flow as a second L4S data flow; and
enqueuing the second upstream data flow in a second L4S queue associated with the second LAS data flow.
